(19) United States
(12) Patent Application Publication
(10) Pub. No.: US 2004/0194761 A1
(43) Pub. Date: Oct. 7, 2004

(54) Piping structure of fuel injection pipes for engine

(76) Inventors: Hatsuo Ando, Oyama-shi (JP); Tatsuya Iwazaki, Oyama-shi (JP); Kanji Namimatsu, Oyama-shi (JP); Takumi Ito, Oyama-shi (JP); Yasuyuki Onodera, Oyama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/806,328

(22) Filed: Mar. 23, 2004

(30) Foreign Application Priority Data
Apr. 4, 2003 (JP) 2003-101452

(51) Int. Cl. F02M 55/02

(52) U.S. Cl. 123/456; 123/468

(57) ABSTRACT

Cylinder heads 100a to 100f are respectively provided with fuel injectors 101a to 101f. Each of the fuel injectors 101a to 101f is connected to each of joints 105a to 105f in a common rail 105 extending linearly through fuel injection pipes 103a to 103f. In this example, it can be achieved to allow all the fuel injection pipes 103a to 103f to have the same length by crossing the injection pipes 103b, 103c, 103d and 103e to connect. With this configuration, it is possible to reduce the irregularities in the amount of fuel injection and to enhance the engine performance.

### BACKGROUND OF THE INVENTION

1. Field of the Invention

The present invention relates to a piping structure of fuel injection pipes applied to a diesel engine and the like. More particularly, the invention relates to a piping structure of fuel injection pipes for an engine having such advantages that irregularities in the amount of fuel injection are reduced to enhance engine performance, or productivity and reliability of the piping structure can be enhanced.

2. Description of the Related Art

Japanese Patent No.2797745 (patent document 1) can be given as one example of known arts with respect to a fuel injection device of an internal combustion engine.

FIG. 7 is a plan view of the fuel injection device disclosed in the patent document 1. A diesel engine shown in FIG. 7 includes six cylinders, and each of fuel injectors (injection valves) 1a to 1f is provided with each of the cylinders. Each of the fuel injectors 1a to 1f is connected to a fuel accumulator 22 via injection pipes 21a to 21f respectively corresponding thereto. The fuel accumulator 22 is formed in a common rail 53 which extends linearly. Fuel exits 22a to 22f are provided in the fuel accumulator 22 in the common rail 53.

A fuel pump 2 is connected to the fuel accumulator 22 in the common rail 53. The fuel pump 2 comprises two pumps, i.e., a first fuel pump 2a and a second fuel pump 2b. The first and second fuel pumps 2a and 2b are connected to the fuel accumulator 22 via fuel supply pipes 37a and 37b respectively corresponding thereto. Fuel is alternately discharged from the first and second fuel pumps 2a and 2b.

In this fuel injection device, as apparent in FIG. 7, the fuel injectors 1a to if are sequentially, from one end to the other, connected to the fuel exits 22a to 22f via the injection pipes 21a to 21f respectively corresponding thereto. That is, the fuel injector 1a is connected to the fuel exit 22a through the injection pipe 21a, and likewise, the valves, exits and pipes are connected in the following manner: the fuel injector 1b [symbol] the injection pipe 21b [symbol] the fuel exit 22b, . . . , the fuel injector 1f [symbol] the injection pipe 21f [symbol] the fuel exit 22f.

In the example shown in FIG. 7, a fuel introducing position (connecting portion for the fuel supply pipes 37a and 37b) for the fuel accumulator 22 is set between the fuel exits 22b and 22c, the fuel exits 22a to 22f are pitched irregularly, and distance between each of the fuel injectors 1a to 1f and each of the fuel exits 22a to 22f is made shorter to thereby allow each of the injection pipes 21a to 21f to have the same length. By allowing each of the injection pipes 21a to 21f to have the same length, the irregularities in the amount of fuel injection are reduced to a low level.

However, with the configuration of the patent document 1 as described above, since the fuel introducing position for the fuel accumulator 22 is set between the fuel exits 22b and 22c, the fuel supply pipes 37 and 37b become long as compared with a case in which, for example, the fuel introducing position is set at an end of the fuel accumulator 22 (a lower section in FIG. 7), and therefore, there is a possibility that reliability is lowered.

Further, with the configuration of the patent document 1, it is necessary to set the positions of the fuel exits 22a to 22f of the fuel accumulator 22 in accordance with cylinder pitches of the engine and thus, the common rail 53 becomes a specified part for each series of engines. Therefore, some kinds of common rails must be prepared in accordance with shapes and types of the engines, which results in the deterioration of productivity and the increase of production cost.

### SUMMARY OF THE INVENTION

The present invention has been accomplished based on the above problems, and it is an object of the invention to provide a piping structure of fuel injection pipes for an engine having such advantages that irregularities in the amount of fuel injection are reduced to enhance engine performance, or productivity and reliability of piping structure can be enhanced.

To solve the above problems, a first piping structure of fuel injection pipes of an engine of the present invention is provided, wherein in a piping structure of fuel injection pipes for an engine, the pipes disposed between fuel injectors (injection nozzles) respectively provided to a plurality of cylinders being disposed in a line and a fuel accumulator (a common rail) which delivers fuel to the fuel injectors, each of the fuel injection pipes is individually connected to each of the fuel injectors of the cylinders, each of the plurality of the fuel injection pipes is individually connected to each of a plurality of fuel exit holes arranged along the longitudinal direction of the common rail and all or some of the plurality of the fuel injection pipes are arranged to be crossed each other.

A second piping structure of fuel injection pipes of an engine of the invention is provided, wherein in a piping structure of fuel injection pipes for an engine, the pipes disposed between fuel injectors respectively provided in a plurality of cylinders being disposed in a line and an in-line pump having a plurality of individual pumps being disposed in a line respectively provided for each of the fuel injectors for pressurizing fuel which is to be delivered to each of the fuel injectors, each of the fuel injection pipes is individually connected to each of the fuel injectors of the cylinders, each of the plurality of the fuel injection pipes is individually connected to the plurality of the individual pumps and all or some of the plurality of the fuel injection pipes are arranged to be crossed each other.

According to the piping structure of the invention, all or some of the plurality of fuel injection pipes are made to be crossed, and thereby it becomes easy to allow the fuel injection pipes to have the same length. Therefore, since the irregularities in the amount of fuel injection can be reduced, the engine performance can be enhanced. Greater effect can be obtained especially when this piping structure is applied to a multi-injection system in which a pilot injection system, a pre-injection system, a post-injection system or the like is provided together with a main injection system. In the piping structure of the invention, since it is unnecessary to sag intermediate portions of the injection pipes nor to form the injection pipes into a shape being complicatedly bent in order to adjust the length of the fuel injection pipes, productivity and reliability can be enhanced.

In the piping structure of fuel injection pipes for an engine, it is possible to allow a plurality of the injection pipes to have the same length or substantially the same length. In this case, the irregularities in the amount of fuel injection can be reduced and the engine performance can be enhanced by allowing each of the fuel injection pipes to have the same length or substantially the same length. Great effect can be obtained especially when this piping structure is applied to a multi-injection system in which a pilot injection system, a pre-injection system, a post-injection system or the like is provided together with a main injection system.

### BRIEF DESCRIPTION OF THE DRAWINGS

FIG. 1 is a plan view showing a piping structure (piping structure of a common rail type) of fuel injection pipes according to an aspect of a first embodiment of the present invention.

FIG. 2(A) is a pattern diagram showing a piping structure of a six-cylinder engine according to an aspect of the embodiment, and FIG. 2(B) is a pattern diagram showing a piping structure of a conventional six-cylinder engine.

FIG. 3 is a plan view showing a piping structure (piping structure of a in-line pump type) of fuel injection pipes according to an aspect of a second embodiment of the invention.

FIGS. 4 are pattern diagrams showing examples of fuel injection pipes with respect to a four-cylinder engine.

FIGS. 5 are pattern diagrams showing examples of fuel injection pipes with respect to a six-cylinder engine.

FIGS. 6 are pattern diagrams showing examples of fuel injection pipes with respect to an eight-cylinder engine.

FIG. 7 is a plan view of a fuel injection device disclosed in the patent document 1.

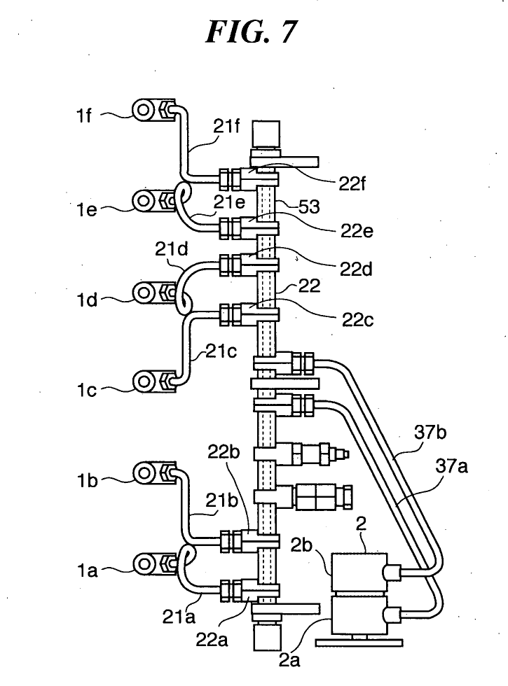

### DESCRIPTION OF THE PREFERRED EMBODIMENT

The present invention will be explained below with reference to the drawings.

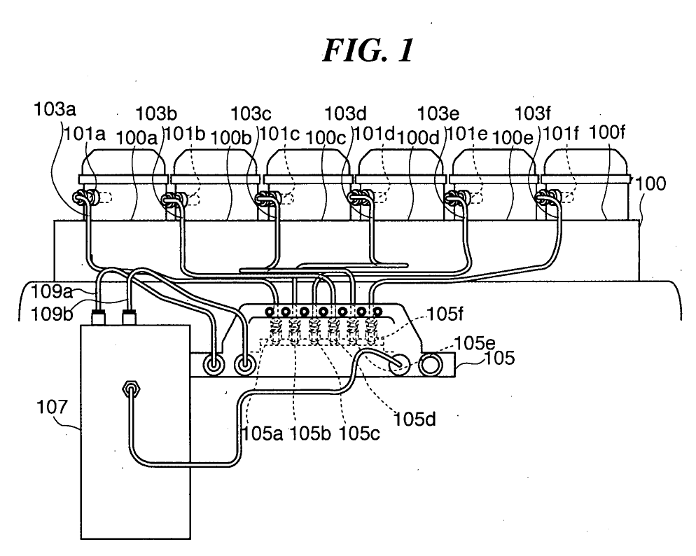

FIG. 1 is a plan view showing a piping structure (piping structure of a common rail type) of fuel injection pipes according to the aspect of the first embodiment of the present invention.

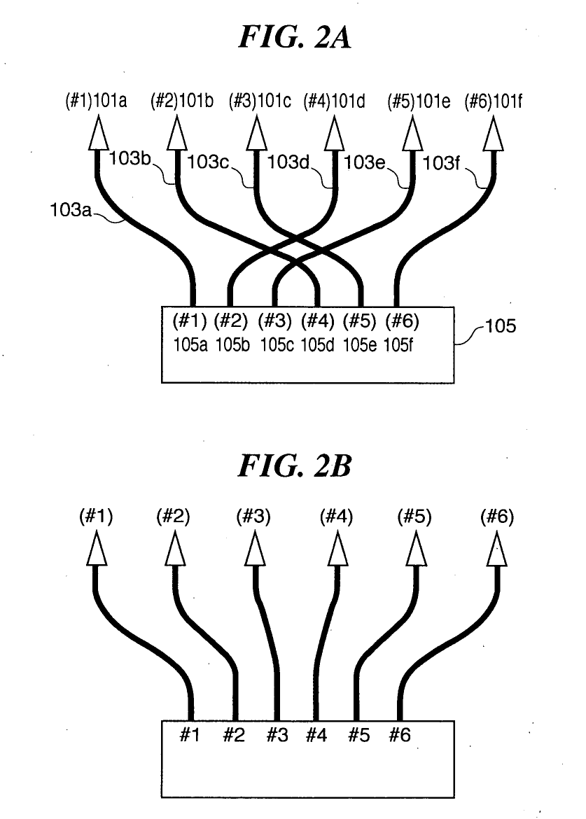

FIG. 2(A) is a pattern diagram showing a piping structure of a six-cylinder engine according to the aspect of the embodiment, and FIG. 2(B) is a pattern diagram showing a piping structure of a conventional six-cylinder engine.

FIG. 1 shows cylinder heads 100 having six cylinders. The cylinder heads 100a to 100f are respectively provided with fuel injectors (injection valves) 101a to 101f. Each tip end of the fuel injectors 101a to 101f is injection nozzle.

Each of the fuel injectors 101a to 101f is connected to each of joints with nuts 105a to 105f (simply referred as joints, hereinafter) in common rail 105 extending linearly through fuel injection pipes 103a to 103f. The common rail 105 is connected to a fuel pump 107. Tow fuel supply pipes 109a and 109b extend from the fuel pump 107. The fuel pump 107 is connected to the common rail 105 through the fuel supply pipes 109a and 109b.

Each end portion of the fuel injection pipes 103a to 103f is inserted into each of the joints 105a to 105f to be connected in the common rail 105 and then is fastened with nuts. Each of the joints 105a to 105f in the common rail 105 serves as fuel exits through which fuel is discharged. As shown in FIGS. 1 and 2(A), each of the fuel injectors 110a to 110f and each of the joints 105a to 105f in the common rail 105 are connected via the fuel injection pipes 103a to 103f according to following relation (1) to (6):

(1) The first fuel injector 101a from the left in the drawing is connected to the first joint 105a from the left in the drawing via the fuel injection pipe 103a.

(2) The second fuel injector 101b from the left in the drawing is connected to the fourth joint 105d from the left in the drawing via the fuel injection pipe 103b.

(3) The third fuel injector 101c from the left in the drawing is connected to the fifth joint 105e from the left in the drawing via the fuel injection pipe 103c.

(4) The fourth fuel injector 101d from the left in the drawing is connected to the second joint 105b from the left in the drawing via the fuel injection pipe 103d.

(5) The fifth fuel injector 11e from the left in the drawing is connected to the third joint 105c from the left in the drawing via the fuel injection pipe 103e.

(6) The sixth fuel injector 101f from the left in the drawing is connected to the sixth joint 105f from the left in the drawing via the fuel injection pipe 103f.

In this embodiment, as in the relation (2) to (5), it can be achieved to allow all the fuel injection pipes 103a to 103f to have the same length by crossing the injection pipes 103b, 103c, 103d and 103e to connect. On the contrary, as shown in FIG. 2(B), if the fuel injection pipes are not made to be crossed and the fuel injectors and the joints (fuel exits) of the common rail are connected to each other in the order of #1 to #6 (as in a general conventional piping structure), it can not be easily achieved to allow all the fuel injection pipes to have the same length.

One example of numeric values will be given. In the case of FIG. 2(A) of the embodiment, it was possible that all the fuel injection pipes were made to have the same length of 701.0 mm, while in the conventional case shown in FIG. 2(B), the lengths of #1 and #6 fuel injection pipes were 691.0 mm, the lengths of #2 and #5 fuel injection pipes were 576.5 mm, the lengths of #3 and #4 fuel injection pipes were 442.0 mm, and irregularities in a range of 1 to 1.56 times were found.

As described above, according to the aspect of the embodiment, it is possible to reduce the irregularities in the amount of fuel injection and to enhance the engine performance by achieving the fuel injection pipes 103a to 103f having the same length. Great effect can be obtained especially when this piping structure is applied to a multi-injection system in which a pilot injection system, a pre-injection system, a post-injection system or the like is provided together with a main injection system. In this aspect of the embodiment, since it is unnecessary to sag intermediate portions of the injection pipes nor to form the injection pipes into a shape being complicatedly bent as compared with the patent document 1 described above, productivity and reliability can be enhanced.

Next, an aspect of a second embodiment of the present invention will be explained.

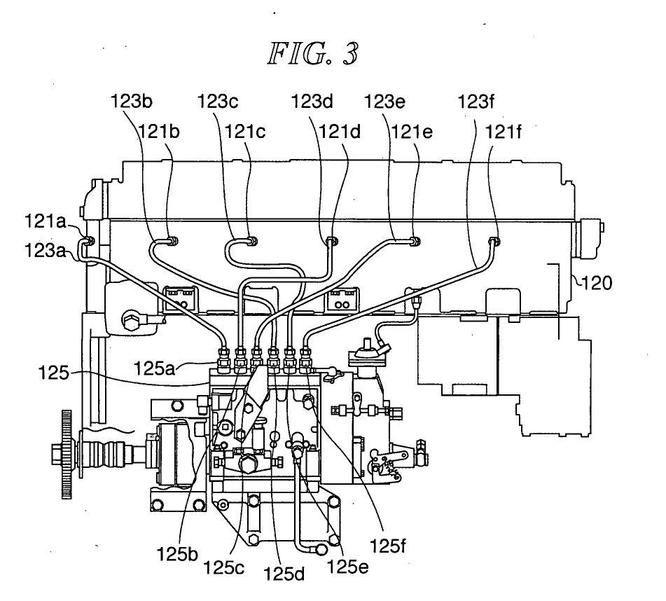

FIG. 3 is a plan view showing a piping structure (piping structure of an in-line pump type) of fuel injection pipes according to the aspect of the second embodiment of the invention.

FIG. 3 shows cylinder heads 120 having six cylinders. The cylinder heads 120 respectively includes fuel injectors (injectors) 121a to 121f. Each tip end of the fuel injectors 121a to 121f is injection nozzle. Each of the fuel injectors 121a to 121f is connected to each of joints (fuel exits) 125a to 125f of an in-line pump 125 having individual pumps through fuel injection pipes 123a to 123f. Each end of the fuel injection pipes 123a to 123f is inserted into each of the joints 125a to 125f in the in-line pump 125 to be connected and then is fastened with nuts.

In the piping structure of this second embodiment as well, with the same relation with (1) to (6) described above (see FIG. 2(A)), it can be achieved to allow all the fuel injection pipes 123a to 123f to have the same length by crossing the injection pipes 123b, 123c, 123d and 123e to connect. Thus, in this case as well, it is possible to reduce the irregularities in the amount of fuel injection and to enhance the engine performance.

Next, examples of the piping structure of the fuel injection pipes with respect to four-cylinder, six-cylinder and eight-cylinder engines will be explained.

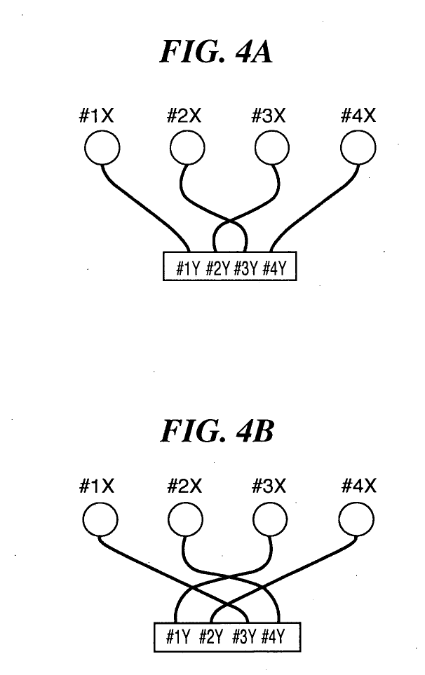

FIGS. 4, 5 and 6 are pattern diagrams respectively showing examples of the piping structure of fuel injection pipes of the four-cylinder, six-cylinder and eight-cylinder engines. In each of these drawings, ◯ (circle) in the upper side represents the fuel injectors and □ (rectangle) in the lower side represents the common rail or in-line pump, and thick lines therebetween represent fuel injection pipes. Numbers are arranged from the left in order, symbols X are added to the ends of the numbers of the fuel injectors represented by ◯, and symbols Y are added to the ends of the numbers of the fuel exits of the common rail or tandem pumps represented by □, thereby distinguishing the fuel injectors and common rail or in-line pumps.

“In the case of four-cylinder engine” shown in FIG. 4(A), the pipes are arranged in accordance with the relation of #1X [symbol] #1Y, #2X [symbol] #3Y, #3X [symbol] #2Y, #4X [symbol] #4Y. In this case, two intermediate fuel injection pipes are crossing. In the case shown in FIG. 4(B), the pipes are arranged in accordance with the relation of #1X [symbol] #3Y, #2X [symbol] #4Y, #3X [symbol] #1Y, #4X [symbol] #2Y. In this case, four fuel injection p are crossing.

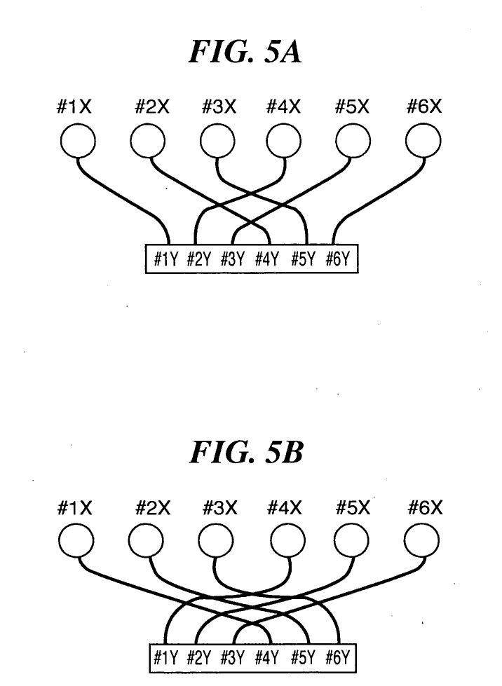

“In the case of six-cylinder engine” shown in FIG. 5(A), the pipes are arranged in accordance with the relation of #1X [symbol] #1Y, #2X [symbol] #4Y, #3X [symbol] #5Y, #4X [symbol] #2Y, #5X [symbol] #3Y, same as shown in FIG. 2(A), and four intermediate fuel injection pipes are crossing.

In the case shown in FIG. 5(B), the pipes are arranged in accordance with the relation of #1X [symbol] #4Y, #2X [symbol] #5Y, #3X [symbol] #6Y, ·#5X [symbol] #2Y, #6X [symbol] #3Y. In this case, six fuel injection pipes are crossing.

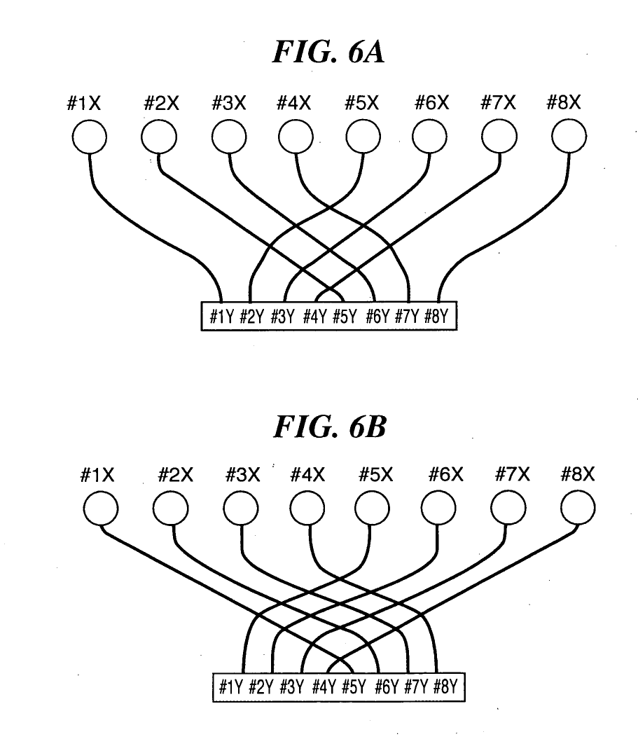

“In the case of eight-cylinder engine” shown in FIG. 6(A), the pipes are arranged in accordance with the relation of #1X [symbol] #1Y, #2X [symbol] #5Y, #3X [symbol] #6Y, #4X [symbol] #7Y, #5X [symbol] #2Y, In this case, six intermediate fuel injection pipes are crossing. In the case shown in FIG. 6(B), the pipes are arranged in accordance with the relation of #1X [symbol] #5Y, #2X [symbol] 4#6Y, #3X [symbol] #7Y, #4X #6X [symbol] #2Y, #7X [symbol] #3Y, #8X [symbol] #4Y. In this case, eight fuel injection pipes are crossing.

If all or some of the fuel injection pipes are crossed to allow the pipes to have the same length other than those shown in FIGS. 4 to 6, other examples of the piping structure can be employed.

As apparent from the above explanation, the present invention can provide a piping structure of fuel injection pipes for an engine having advantages that irregularities in the amount of fuel injection are reduced to enhance engine performance and productivity and reliability of the piping structure can be enhanced.

1. A piping structure of fuel injection pipes for an engine, the pipes disposed between the fuel injectors respectively provided to a plurality of cylinders being disposed in a line and a fuel accumulator (a common rail) which delivers fuel to the fuel injectors, wherein
each of the fuel injection pipes is individually connected to each of the fuel injectors of the cylinders;
each of the plurality of the fuel injection pipes is individually connected to each of a plurality of fuel exit holes arranged along the longitudinal direction of the common rail; and
all or some of the plurality of the fuel injection pipes are arranged to be crossed each other.

2. A piping structure of fuel injection pipes for an engine, the pipes disposed between the fuel injectors respectively provided to a plurality of cylinders being disposed in a line and an in-line pump having a plurality of individual pumps being disposed in a line respectively provided for each of the fuel injectors for pressurizing fuel which is to be delivered to each of the fuel injectors, wherein
each of the fuel injection pipes is individually connected to each of the fuel injectors of the cylinders;
each of the plurality of the fuel injection pipes is individually connected to the plurality of the individual pumps; and
all or some of the plurality of the fuel injection pipes are arranged to be crossed each other.

3. A piping structure of fuel injection pipes for an engine according to claim 1, wherein the plurality of the injection pipes have the same length or substantially the same length.

4. A piping structure of fuel injection pipes for an engine according to claim 2, wherein the plurality of the injection pipes have the same length or substantially the same length.
